(19) United States
(12) Patent Application Publication
(10) Pub. No.: US 2002/0114914 A1
(43) Pub. Date: Aug. 22, 2002

(54) Bonding agents for polymeric planks and methods of adjoining polymeric planks

(76) Inventors: Hao A. Chen, Chadds Ford, PA (US); Richard Judd, Newark, DE (US)

Correspondence Address: Luke A. Kilyk, Esq., KILYK & BOWERSOX, P.L.L.C., 3603-E Chain Bridge Road, Fairfax, VA, 22030, US

(21) Appl. No.: 09/736,820

(22) Filed: Dec. 14, 2000

Related U.S. Application Data
(60) Provisional application No. 60/177,684, filed on Jan. 24, 2000.

(51) Int. Cl. B32B 3/00

(52) U.S. Cl. 428/57; 156/304.1

(57) ABSTRACT

A surface covering system is described where two or more polymeric planks are connected to each other by a bonding agent which contains at least one solvent capable of at least bonding the edges of the polymeric portion of the planks wherein the bonding agent is present on at least one edge of at least one plank and/or is present on a connector, like a spline, if one is used, in joining the planks. Also described is a method to connect two or more polymeric planks which involves applying the bonding agent to at least one plank edge and/or spline, if present, prior to or after connecting the second or more planks together.

This application claims the benefit under 35 U.S.C. §119(e) of prior U.S. Provisional Application No. 60/177,684 filed Jan. 24, 2000, which is incorporated in its entirety by reference herein.

### BACKGROUND OF THE INVENTION

The present invention relates to polymeric planks and methods of installing polymeric planks.

Thermoplastic materials were developed to overcome many of the disadvantages of commercially available laminate flooring using fiber board or particle board as the core layer. However, there is a need to adjoin planks together in order to ensure that the overall floor covering system remains intact, does not shift or drift from the traffic, and is resistant to liquids that may come into contact with the surface of the surface covering system.

If one skilled in the art takes the traditional approach to adjoining surface covering products, such as using a one part or two part adhesive system using such glues as polyurethane adhesives or epoxy adhesives or performing hot welding or using ultra sonic welding techniques, these methods of adhering would not be commercially suitable to thermoplastic planks because they are time consuming, lead to a product which would not be pleasing to the user, would be quite expensive or would have unsatisfactory performance.

Accordingly, there is a need to provide a bonding system for thermoplastic planks which is relatively inexpensive, provides an excellent bond between planks, and which is moisture resistant and provides an overall acceptable bond strength between two joined boards.

### SUMMARY OF THE INVENTION

A feature of the present invention is to provide a method of chemically adjoining polymeric planks in order to form a surface covering system.

Another feature of the present invention is to provide a bonding or chemical welding agent which can join or bond two or more planks together as well as provide an excellent bonding strength between the joints.

Another feature is to provide a sealant effect which excludes water, cleaning liquids used in floor maintenance, or liquids from the room environment from seeping through the joined plank surfaces to the sub-surface below the plank surface.

Additional features and advantages of the present invention will be set forth in the description which follows, and in part will be apparent from the description or may be learned by practice of the present invention. The features and other advantages of the present invention will be realized and obtained by means of the elements and combinations particularly pointed out in the written description and appended claims.

To achieve these and other advantages and in accordance with the purposes of the present invention, as embodied and broadly described herein, the present invention relates to a surface covering system comprising two or more polymeric planks, wherein the planks are connected to each other by a bonding agent which is applied to one or more edges of one or more planks. The bonding agent is capable of adhering the polymeric portions of the planks to form a strong bond at the joint after the bonding agent is properly set.

The present invention further relates to a method to connect two or more polymeric planks involving the step of applying a bonding composition on at least one edge of a plank and then contacting a second plank such that at least one edge of each plank is brought into contact with each other and letting the composition set to form two or more polymeric planks which are bonded together. The bonding composition is capable of adhering the polymeric portions of the planks. In an alternative method, the bonding agent can be applied to pre-assembled planks.

It is to be understood that both the foregoing general description and the following detailed description are exemplary and explanatory only and are intended to provide a further explanation of the present invention, as claimed.

### DETAILED DESCRIPTION OF THE PRESENT INVENTION

In general, the present invention relates to a surface covering system for polymeric planks, preferably thermoplastic planks, wherein the planks (or at least one side thereof) are connected to each other with the use of a bonding agent or composition. The bonding agent or composition can also be considered a chemical welding agent. The bonding agent or composition contacts one or more edges of at least one of the individual planks or the bonding agent is applied at the joint between two planks. The penetration of the bonding agent to at least one edge in the joint of the planks is capable of forming a strong bond. The bonding agent may form a bond by chemically welding the planks or other parts of the surface covering system together.

The present invention also involves a method to connect two or more polymeric planks. The method involves the step of applying a bonding composition to at least one edge of the plank and then contacting this plank with a second plank such that at least one edge of each plank is brought into contact with each other and thereby connected before the composition is dried and set. The composition can also be applied to one or more edges of the second plank.

The present invention further involves connecting two or more polymeric planks by pre-assembling two or more planks together with or without a spline or other joining system and then applying the bonding agent or composition to the joints formed between the two or more polymeric planks. The two or more polymeric planks will thus be joined or melted together by the bonding agent flowing between the surfaces in contact with each other.

In more detail, the surface covering which the planks can form can be any type of surface covering such as a floor, wall, ceiling, deck, patio, kitchen countertop, and the like.

The thermoplastic plank can be a plank wherein the core of the plank contains at least one thermoplastic material. The core can be formed by extrusion techniques or other techniques. The shape and thickness of a core can be any parameter as long as the plank is capable of being used in a surface covering system. Further details concerning a preferred embodiment of the thermoplastic plank are set forth in U.S. patent application Ser. Nos. 09/460,928 and 09/630,121, both entitled “THERMOPLASTIC PLANKS AND METHODS FOR MAKING THE SAME,” incorporated in its entirety by reference herein. Typically, the thermoplastic plank is a plank wherein the core of the plank is thermoplastic and a design layer is located on top of the core or a design is printed directly on the core itself. Further, as described in the above-identified application, the plank can have a variety of surface layers such as wear layers, top layers, and the like. Typically, a laminate will be located on the thermoplastic core for purposes of providing the design and textured appearance of the plank.

In more detail, the core in the thermoplastic laminate plank is made of at least one thermoplastic material. Generally, any thermoplastic material, combinations thereof, alloys thereof, or mixtures of two or more thermoplastics can be used to form the core. Generally, such thermoplastic materials include, but are not limited to, vinyl containing thermoplastics such as polyvinyl chloride, polyvinyl acetate, polyvinyl alcohol, and other vinyl and vinylidene resins and copolymers thereof; polyethylenes such as low density polyethylenes and high density polyethylenes and copolymers thereof; styrenes such as ABS, SAN, and polystyrenes and copolymers thereof; polypropylene and copolymers thereof; saturated and unsaturated polyesters; acrylics; polyamides such as nylon containing types; engineering plastics such as acetal, polycarbonate, polyamide, polysulfone, and polyphenylene oxide and sulfide resins and the like. One or more conductive polymers can be used to form the plank, which has applications in conductive flooring and the like. The thermoplastic polymers set forth in Kirk Othmer (3^{rd} Edition, 1981) at pp. 328 to 848 of Vol. 18 and pp. 385-498 of Vol. 16, (incorporated in their entirety by reference herein) can also be used as long as the resulting plank has sufficient strength for its intended purpose.

Specifically, a preferred thermoplastic plank used in a surface covering system has at least four corners and has a tongue and/or groove system for receiving a spline system and/or other thermoplastic planks in order to form a surface covering system. The plank can be any shape and can also be known as a tile or any other term associated with surface coverings.

The present invention involves a surface covering system wherein a composition which contains a bonding agent is applied to at least one edge of a plank in order to connect with a second plank and so on in order to form a surface covering system. The composition can be applied to at least one edge or be applied to two or more edges of the same plank. Further, when connecting two or more planks together, the composition can be applied to each edge of each plank to be connected or just to one of the plank's edge to be connected together. When a polymeric spline system or other polymeric joining mechanism is used to join planks together, the composition can be applied to the spline itself or to one or more or all of the surfaces that are joined together. For purposes of this invention, spline as used therein includes all types of joining mechanisms wherein at least a portion of the mechanism is made from polymeric materials.

The composition can be applied by any means known to those skilled in the art such as with a brush, by dipping the plank in the composition, by spraying techniques, by nozzle, by use of a syringe-type device, and the like. Preferably, the composition is applied through a nozzle or with a syringe-type applicator. One advantage of the composition of the present invention is that the composition can come in contact with other surfaces of the plank and preferably be removed with soap and water so that is does not stain or damage the top surface of the plank which can contain a print layer or other layer. In fact, because the bonding agent is free of residue, no clean up at all is necessary after the application.

Typically, at least a portion of the edge receives the composition and more preferably the entire edge surface in order to ensure a good bonding connection with the second plank to be connected. In addition or alternatively, as discussed above, if a spline is used, the spline alone and/or the edge(s) of the plank can receive the composition.

Also, as indicated above, the planks can be preassembled and then the bonding agent can be applied by any means such as with a syringe-type applicator to the joints between the planks. The bonding agent will then seep through the cracks in the joints thereby welding the planks together and thus ensure a good bonding connection between two or more planks. Further, the application of the bonding agent, especially in this manner, provides an excellent sealant which avoids the introduction of liquids or other undesired material from entering between the joints of polymeric planks which are connected together.

Typically, the composition can be cured or set by just letting the connected planks remain untouched for one hour or more, and more preferably for at least 12 hours, and most preferably for at least 24 hours at ambient temperature. The curing time can be shortened by subjecting the connected planks to higher temperatures. Preferably, applying a directed airflow over the area can shorten the setting time.

With respect to the bonding agent or composition, the bonding agent or composition contains a compound capable of dissolving the thermoplastic material forming the core of the plank. Also, if a spline is used, the spline material can be chosen to interact with the bonding agent so that the edges of the core of the plank and spline are all welded together into a joint. These compounds are typically considered solvents. Preferred examples of the solvents include, but are not limited to, tetrahydrafuran (THF), cyclohexanone, methylene chloride, dimethyl formamide, toluene, acetone, ethylene dichloride, methyl ethyl ketone, n-methyl pyrrolidone, methyl isobutyl ketone, dipropyl ketone, isophorone, methyl amyl ketone, nitrobenzene, methyl cyclohexanone, and acetonyl acetone. Preferably, the solvent is tetrahydrafuran or a methyl alkyl ketone or an alkyl alkyl ketone. Mixtures of two or more solvents can be used to form the bonding agent or composition. For instance, tetrahydrafuran and methyl alkyl ketone can be used as a mixture in any ratio. Preferably, the tetrahydrafuran is present in a higher amount than the methyl alkyl ketone, such as methyl ethyl ketone. Preferably, the ratio of tetrahydrafuran to methyl ethyl ketone is 9:1 to 1:1 based on a weight percent. Other combinations of solvents can also be present in the bonding agent or composition. Depending upon the particular thermoplastic forming the core of the plank, certain solvents are more effective in increasing the bonding strength between two connected planks. For instance, when the core is made of polyvinyl chloride, tetrahydrafuran is quite effective as well as methyl ethyl ketone and nitrobenzene. When the thermoplastic forming the core is an acrylonitrile-butadiene-styrene polymer (ABS resin), methylene chloride, toluene, acetone, ethylene dichloride, methyl ethyl ketone, and/or tetrahydrafuran are quite effective in achieving high bonding strengths between two connected planks or tiles. It is within the bounds of the application to include mixtures of various solvents as long as the solvents do not negatively affect the ability to achieve bonding between two or more planks or tiles. The solvents are commercially available from several sources.

The solvent can be diluted with water or other media. Typically, the concentration of the solvent is from about 80% by weight to about 100% by weight, more preferably the concentration of the solvent is from about 90% by weight to about 100% by weight, and even more preferably the solvent is present in a concentration of from about 95% by weight to about 100% by weight, and most preferably the solvent is present in a concentration of 100% by weight of bonding agent.

Other ingredients can be included with the bonding agent such as fillers, silica, cyclohexanone, PVC resin, surfactants, and the like in conventional amounts.

The present invention will be further clarified by the following examples, which are intended to be purely exemplary of the present invention.

### EXAMPLES

### Example 1

A series of thermoplastic planks were connected together to create a flooring system. The planks had a groove on two opposite edges. A spline (e.g., tongue portion) was used to join edges together of two planks. The two remaining edges of the plank had no groove. In addition, a comparison was made with using no bonding agent and a flooring system using a bonding agent. The bonding agent, tetrahydrofuran (THF) was applied to all sides of the plank including the spline and grooves once the planks with spline were pre-assembled. When no THF was applied to the spline area, the bonding strength was an average of 1.73 pounds using the Instron Universal Tester pulling the bond apart with tension using the following parameters: 50 pound full scale load, jaw speed 0.5 inch/min, three-inch jaw separation at start of test, 1″×5″ sample with 0.156 inch spline thickness. When the same type of extrusion plank had THF applied to the spline area, after 4 hours of setting, the bonding strength of the spline area was an average of 18.1 pounds and after 24 hours curing, the bonding strength of the spline area was 39.1 pounds. When the test was repeated with a 152 mil spline with THF, using the INSTRON test, after a 24 hour cure, the bonding strength was an average of 45.37 pounds.

The ends of the extrusion plank were tested for bonding strength wherein the ends have no spline attachment and simply butted against each other. There was no bonding strength when no THF was present since there is nothing holding the edges of each plank together. When THF was applied to the edges after 4 hours cure, the bonding strength was over 100 pounds using a 100 pound scale, and after a 24 hour cure, the bonding strength was over 100 pounds using a 100 pound scale. Although the butt ends are not joined by a spline, the effective contact area is large and the bond strengths were over 100 pounds as described. The variation of the bonding strength can be influenced by such factors as 1) vertical groove opening, 2) thickness of the spline, 3) effective contact areas with surfaces close enough to allow the bonding agent to join them.

A rolling load test was then used to determine the strength of the bond with respect to a heavy flexing load. In this test, a 20×30 inch panel was used wherein half of the panel was held by the spline and also THF-bonded and allowed to dry and set for 24 hours. The other half of the panel had only splines holding the panels together. This panel was then placed on a carpet and a 165 pound weight supported by one hard rubber wheel 1.25 inches wide was allowed to roll repeatedly over the bonded joint. This resulted in a severe flexing motion on the joint. The product joined simply by the spline system with a 156-mil thick spline separated after 20 cycles. The other half of the product, which was held by the spline and also bonded with THF, did not separate after 150 cycles. This was impressive considering the panel was not glued down to any surface.

A second panel with bonded joint was then made and placed on a reinforced cementitious board (Sterling Board). The joint was shimmed with a piece of felt 0.026 inches thick placed under the plank on one side of the seam. This created a differential height with the purpose of applying a shearing load on the bonded joint. The rolling load test resulted in no separation or breaking of the joint bond.

Preparing a joint between the flat end surfaces of the thermoplastic plank tested the water- sealing capability of the bonded joint. This bonded joint was prepared by placing the ends in flush proximity and applying the THF on top of the joint and allowing it to penetrate into the joint. The bond was allowed to dry and set. Next, a three-inch ID pipe was placed over the joint and sealed at the base with silicon caulk. Floor-rinsing solution in water was placed in a twelve-inch high pipe. If the joint is not well sealed, solution placed in the pipe will force its way into the joint and flow through the joint and out of the tube. This will dampen the paper towel placed beneath the joint. After ten minutes, minimal leakage had occurred through the bonded joint. However, significant leakage was evident through the unbonded joint.

In view of the above testing, these examples show that the addition of THF as a bonding agent provides significant strength advantages to the overall surface covering systems and also prevents water penetration to the subfloor especially at the plank ends where there is no spline system used.

### Example 2

Using the planks or tiles wherein the core is made from polyvinyl chloride as described in U.S. patent application Ser. No. 09/460,928, the planks were made wherein a spline having two tongue portions was inserted into a groove of one plank and then the other tongue section was inserted into the groove of a second plank in order to join two planks together. The solvents set forth in Table 1 (at a 100% concentration) were applied over the entire joining sections of the spline and grooves of the two planks and then the planks with splines were joined together. After 48 hours, the bonding strength, using ASTM D-638 (modified) tensile strength measurement (run at 0.5 inch cross-head speed), was determined based on the parameters set forth in the footnote of the Table. As can be seen, there were a number of solvents which significantly increased the bonding strength as compared to the control, where no solvents were used.

TABLE 1

Measurement *(lbs)

| Solvent | #1 | #2 | #3 | Avg. |
|---|---|---|---|---|
| No Solvent | 3.2 | 7.1 | 5.7 | 5.3 |
| THF | 39.8 | 33.2 | 37.3 | 36.8 |
| Cyclohexanone | 7.6 | 7.6 | 8.7 | 8.0 |
| Methylene Chloride | 12.6 | 10.7 | 12.6 | 12.0 |
| N-Methyl Pyrrolidone | 14.4 | 11.1 | 13.8 | 13.1 |
| Methyl Isobutyl Ketone | 12.1 | 16.7 | 17.5 | 15.4 |
| Dimethyl Formamide | 10.2 | 11.2 | 9.6 | 10.3 |
| Dipropyl Ketone | 16.1 | 12.6 | 21.5 | 16.7 |
| Isophorone | 16.5 | 25.3 | 24.0 | 21.9 |
| Methyl Amyl Ketone | 32.1 | 34.5 | 21.0 | 28.9 |
| Methyl Ethyl Ketone | 50.6 | 48.3 | 54.8 | 51.2 |
| Nitrobenzene | 22.4 | 33.8 | 28.7 | 28.3 |
| Methyl Cyclohexanone | 23.2 | 21.5 | 29.5 | 24.7 |
| Acetonyl Acetone | 12.0 | 13.2 | 12.4 | 12.5 |

*Instron test parameters: .5 in/min; 100 lb scale; 3″ jaw distance

### Example 3

In this example, commercially available Wilsonart Pro FX planks (ABS plank) with a tongue and groove design were tested. In this example, various solvents were tested on two Wilsonart Pro FX planks to determine the bonding strength achieved using the solvents of the present invention. As can be seen in Table 2, when the solvent (at 100% concentration) was applied to the tongue and groove sections of two planks and the planks joined together, after 48 hours, a significant increase in bonding strength was achieved using the various solvents of the present invention. Again, the bonding strength was determined based on the INSTRON test parameters (as set forth in the footnote of the table) following ASTM procedure D-638 (modified to 0.5 inch/min cross-head speed) to determine the tensile strength measurement.

The numbers indicated in Tables 1 and 2 reflect bonding strength in pounds per inch. These numbers indicate the force required to separate two one-inch wide samples bonded at the tongue and the groove joint. The bond was allowed to dry and set for 48 hours before the test.

TABLE 2

Measurement (lbs/inch)

| Solvent | #1 | #2 | #3 | Avg. |
|---|---|---|---|---|
| No Solvent | 0.0 | 0.0 | 0.0 | 0.0 |
| THF | 131.2 | 131.2 | 131.2 | 131.2 |
| Cyclohexanone | 76.8 | 66.4 | 72.6 | 71.9 |
| Methylene Chloride | 131.2 | 131.2 | 131.2 | 131.2 |
| Dimethyl Formamide | 96.8 | 98.1 | 94.7 | 96.5 |
| Toluene | 131.2 | 131.2 | 131.2 | 131.2 |
| Acetone | 126.2 | 117.4 | 131.2 | 124.9 |
| Ethylene Dichloride | 128.9 | 121.2 | 94.8 | 115.0 |
| Methyl Ethyl Ketone | 131.2 | 131.2 | 131.2 | 131.2 |

### Example 4

In this example, blends of various solvents were prepared in the formation of the bonding agent of the present invention. The table sets forth the various blends and the amount of each component in the blend. Table 3 sets forth the bonding strengths of the polymeric planks connected together. The bonding strength was measured in the same manner as in Example 1. Further, a six hour leak test was also conducted on the joined planks wherein an amount of water was poured on top of the joined planks to determine if any leakage between the joints of the planks occurred. In each instance, no significant leakage was detected. The results of this example are set forth in Table 3.

Three blends were used: (1) 50 (THF) 50 (MEK); (2) 75 (THF) 25 (MEK) (3) 90 (THF) 10 (MEK), each number reflecting % by weight of composition.

TABLE 3

| Sample No. | | THF/MEK 50/50 | THF/MEK 75/25 | THF/MEK 90/10 |
|---|---|---|---|---|
| | 1 | 106.6 | 92.4 | 74.6 |
| Bonding | 2 | 118.4 | 105.9 | 85.1 |
| Strengths | 3 | 146.3 | 71 | 111 |
| (PSI) | 4 | 69.5 | 142 | 81.4 |
| | 5 | 104.5 | 109.6 | 112.6 |
| | 6 | 114.6 | 111 | 98.1 |
| | 7 | 82.6 | 110.7 | |

| | | | |
|---|---|---|---|
| AVG. | 109.9833 | 102.0714 | 96.21429 |
| 6 Hr. | Pass | Pass | Pass |
| Leak Test | | | |

Other embodiments of the present invention will be apparent to those skilled in the art from consideration of the specification and practice of the present invention disclosed herein. It is intended that the specification and examples be considered as exemplary only, with the true scope and spirit of the present invention be indicated by the following claims and equivalents thereof.

1. A surface covering comprising two or more polymeric planks having edges, wherein said planks are connected to each other by a bonding agent, wherein said bonding agent is present on at least one of the edges of at least one of the planks, and wherein said bonding agent comprises at least one solvent capable of at least bonding the edges of the planks.

2. The surface covering of claim 1, wherein said bonding agent consists essentially of tetrahydrafuran.

3. The surface covering of claim 1, wherein said bonding agent consists of tetrahydrafuran.

4. The surface covering of claim 1, wherein said bonding agent comprises tetrahydrafuran, cyclohexanone, methylene chloride, dimethyl formamide, toluene, acetone, ethylene dichloride, methyl ethyl ketone, n-methyl pyrrolidone, methyl isobutyl ketone, dipropyl ketone, isophorone, methyl amyl ketone, nitrobenzene, methyl cyclohexanone, acetonyl acetone, or combinations thereof.

5. The surface covering of claim 1, wherein said bonding agent is present on at least each edge of each thermoplastic plank connected together to another thermoplastic plank.

6. The surface covering of claim 1, wherein said bonding agent is present on two opposite edges of each individual plank.

7. A method to connect two or more thermoplastic planks comprising the step of applying a bonding agent to at least one edge of a plank and then connecting an edge of a second plank to said edge having said bonding agent to connect the planks together;
wherein said bonding agent comprises at least one solvent capable of bonding at least the edges of the planks.

8. The method of claim 7, wherein said bonding agent comprises tetrahydrafuran.

9. The method of claim 7, wherein said bonding agent comprises tetrahydrafuran, cyclohexanone, methylene chloride, dimethyl formamide, toluene, acetone, ethylene dichloride, methyl ethyl ketone, n-methyl pyrrolidone, methyl isobutyl ketone, dipropyl ketone, isophorone, methyl amyl ketone, nitrobenzene, methyl cyclohexanone, acetonyl acetone, or combinations thereof.

10. The method of claim 7, wherein said bonding agent consists essentially of tetrahydrafuran.

11. The method of claim 7, wherein said bonding agent consists of tetrahydrafuran.

12. The method of claim 7, wherein said bonding agent is applied to each edge of each thermoplastic plank connected to another thermoplastic plank.

13. The method of claim 7, wherein said bonding agent is applied to two or more edges of at least one plank.

14. The method of claim 7, wherein said bonding agent is applied with a brush.

15. The method of claim 7, wherein said bonding agent is applied by spraying.

16. The method of claim 7, wherein said bonding agent is applied by dipping at least one edge of said plank in a container containing said bonding agent.

17. The method of claim 7, wherein said bonding agent is applied with a syringe-type applicator.

18. The method of claim 7, wherein said step of applying said bonding agent is repeated to connect a multiplicity of planks together to form a surface covering.

19. A surface covering comprising two or more polymeric planks and splines located between at least a portion of said polymeric planks, wherein at least a portion of said planks and splines are connected to each other by a bonding agent comprising at least one solvent capable of bonding at least the spline and plank together, wherein said bonding agent is applied to at least one of the edges of at least one of the individual planks, splines, or both.

20. The surface covering of claim 19, wherein said bonding agent comprises tetrahydrafuran, cyclohexanone, methylene chloride, dimethyl formamide, toluene, acetone, ethylene dichloride, methyl ethyl ketone, n-methyl pyrrolidone, methyl isobutyl ketone, dipropyl ketone, isophorone, methyl amyl ketone, nitrobenzene, methyl cyclohexanone, acetonyl acetone, or combinations thereof.

21. A method to connect two or more thermoplastic planks with at least one spline connecting the planks comprising the step of applying a bonding agent comprising at least one solvent capable of at least bonding the plank and spline together to at least one edge of a plank, a spline connecting planks, or both, and then connecting an edge of a second plank to said spline to connect the planks together.

22. The surface covering of claim 1, wherein said polymeric plank is in the shape of a tile.

23. The surface covering of claim 1, wherein said polymeric plank has a polymeric core with a laminate affixed on the surface of the core.

24. A method to connect two or more thermoplastic planks comprising the step of connecting two or more planks together wherein joints are formed between the connected planks; and applying a bonding agent to said joints;
wherein said bonding agent comprises at least one solvent capable of at least bonding the edges of the polymeric portion of the plank.

25. The method of claim 24, wherein said bonding agent comprises tetrahydrafuran.

26. The method of claim 24, wherein said bonding agent is applied through a nozzle.

27. The surface covering of claim 1, wherein said bonding agent comprises at least two different solvents capable of at least bonding the edges of the polymeric portion of the plank.

28. The method of claim 7, wherein said bonding agent comprises at least two different solvents capable of at least bonding the edges of the polymeric portion of the plank.

29. A method to connect two or more thermoplastic planks with at least one spline connecting the planks comprising the step of preassembling the polymeric planks with at least one spline to form joints at least between the spline and planks;
applying a bonding agent to the joints to bond the planks and spline together; wherein said bonding agent comprises at least one solvent capable of at least bonding the edges of the polymeric portion of the plank, spline, or both.

30. The method of claim 29, wherein said bonding agent is applied through a nozzle.
